(19) United States
(12) Patent Application Publication
(10) Pub. No.: US 2016/0091152 A1
(43) Pub. Date: Mar. 31, 2016

(54) Object Location Assembly

(71) Applicant: Michael E. Fossler, Elk City, OK (US)

(72) Inventor: Michael E. Fossler, Elk City, OK (US)

(73) Assignee: A1AMMO LLC, Elk City, OK (US)

(21) Appl. No.: 14/496,908

(22) Filed: Sep. 25, 2014

(51) Int. Cl. F21L 4/02; F21V 33/00; F21V 23/04

(52) U.S. Cl. CPC F21L 4/02; F21V 23/0414; F21V 33/0064

(57) ABSTRACT

An object location assembly is described and which includes a housing which is mounted on an object of interest; a plurality of selectively energizable electromagnetic radiation emitters which are mounted on the housing, and which, when energized, assist a user in visually locating the object of interest in an environment which has reduced ambient lighting conditions; and an electrical switch which is borne by the housing, and which energizes the plurality of selectively energizable electromagnetic radiation emitters when the object of interest is displaced from the user's body.

### TECHNICAL FIELD

The present invention relates to an object location assembly, and more specifically, to such an assembly which helps a user visually find an object of interest when it is displaced from the user's body, and located in an environment which has reduced ambient lighting conditions.

### BACKGROUND OF THE INVENTION

There are numerous activities undertaken during reduced ambient lighting conditions and where an object of interest such as a tool; firearm; or other item may inadvertently be dropped by or separated from a user, and which must then be located and retrieved. For example, law enforcement, military personnel, first responders, and firefighters often operate under adverse conditions where ambient lighting is at a minimum or virtually non-existent. Often, these individuals carry hand held objects such as radios, flashlights, tools and firearms, and which, if dropped under these adverse lighting conditions, are difficult to locate, and then retrieve, so that their given mission, or task can be successfully completed.

Heretofore, and in the case of firearms, the only previous option available to retrieve a displaced or dropped firearm was to employ a so called “glow in the dark” weapons casing or handle, or further to use a lanyard which is attached to the object and to the user. As will be appreciated, and under certain circumstances such as military and law enforcement applications, the users of such prior art “glow in the dark” devices could not gain a tactical advantage under reduced lighting conditions because such “glow in the dark” devices could inadvertently alert a hidden assailant as to the user's location. Lanyards, on the other hand, while reliable, create other problems where such devices can inadvertently snag or otherwise engage adjacent objects, and which could potentially cause injury to the user or jeopardize a given task or mission. Still further, it should be readily apparent that such “glow in the dark” devices do not readily allow a user to extinguish the light signature provided by such devices while the device is being employed. This is quite important because users do not want such devices to function as an aiming point for an assailant utilizing a firearm or other weapon.

In addition to the foregoing, the aforementioned “glow in the dark” devices did not allow a user to readily visually perceive the displaced firearm's orientation relative to the user when it was being retrieved. As those skilled in the art will recognize, it is important to pick-up a firearm in an appropriate manner such that the muzzle end of the firearm faces away from the user or others accompanying the user, so as to prevent a possible accidental discharge of the firearm from sending a projectile into the user who is retrieving the displaced firearm, or perhaps injuring other parties who are accompanying the user of the firearm.

Those skilled in the art will recognize that there have been a number of design attempts to address these and other shortcomings and problems associated with displaced objects of interest. For example, the Patent Office's attention is directed to U.S. Pat. No. 6,785,996 to Danner and which discloses a sensor system which is designed to disable a firearm when it has been dropped. Still further, the Office's attention is directed to U.S. Pat. No. 8,387,294 and which discloses a firearm having a light which is intended to flash as an early warning sign to adjacent police officers who may encounter an off duty police officer, or other undercover agent. Still further, the Office's attention is directed to U.S. Pat. No. 5,822,905 and which discloses a method for controlling a firearm and which includes buttons that can be engaged on the grip of the firearm. This particular device permits a user to activate accessories quickly and without repositioning the user's hand on the firearm. While these and other devices are suitable for the specific purposes for which they were designed, the problems associated with locating objects of interest in reduced ambient lighting conditions remain. The present invention, as discussed hereinafter, addresses the shortcomings in the prior art devices and practices utilized heretofore, and further provides a means for quickly locating a displaced object of interest under adverse or reduced lighting conditions, and retrieving such objects in and appropriate, and a safe manner.

### SUMMARY OF THE INVENTION

A first aspect of the present invention relates to an object location assembly which includes a housing which is mounted on an object of interest, and which is carried by a user, and wherein the object of interest has opposite ends, opposite sides, and top and bottom portions; and a multiplicity of selectively energizable electromagnetic radiation emitters which are mounted in a predetermined spatial pattern on the housing, and which, when selectively energized, emits electromagnetic radiation which allows the user, under a reduced ambient lighting condition, to readily discern the relative orientation of the object of interest when the object of interest is located at a predetermined distance away from the user.

Another aspect of the present invention relates to an object location assembly which includes a housing which is mounted on an object of interest, and which is carried on a user's body; a plurality of selectively energizable electromagnetic radiation emitters which are mounted on the housing, and which, when energized, assist the user in visually locating the object of interest when the object of interest is displaced from the user's body, and located in an environment which has reduced ambient lighting conditions; and an electrical switch which is borne by the housing, and which energizes the plurality of selectively energizable electromagnetic radiation emitters when the object of interest is displaced from the user's body.

Yet still another aspect of the present invention relates to an object location assembly which includes a flexible or resilient housing which is releasably mounted on an object of interest, and which is further carried by a hand of a user, and wherein the object of interest, from time-to-time, can be inadvertently released by the hand of the user, and be displaced a given distance from the user; a plurality of selectively energizable light emitters mounted on the flexible housing, and which are further oriented in a predetermined spatial pattern, and wherein the selectively energizable light emitters, when energized, assist the user in visually perceiving the object of interest, and the relative orientation of the object of interest, and which is displaced from the user, under an environmental condition which has reduced ambient light; and a pair of electrical switches which are borne by the flexible housing, and which operably, in combination, selectively energize the respective light emitters which are mounted on the flexible housing when the object of interest is displaced from the hand of the user.

These and other aspects of the present invention will be described in greater detail hereinafter.

### BRIEF DESCRIPTION OF THE DRAWINGS

Preferred embodiments of the invention are described below with reference to the following accompanying drawings.

FIG. 1 is a perspective, exploded, side elevation view of the object location assembly of the present invention and which is shown in a displaced orientation relative to an object of interest, and which is herein illustrated as a hand-held firearm of conventional design.

FIG. 2 is a perspective, side elevation view of the object location assembly of the present invention, and which is shown, as it would be installed, or employed on a hand held firearm of traditional design.

FIG. 3 is a side elevation view of a second form of the present invention and which is useful on an object of interest such as a hand held firearm as illustrated in FIGS. 1 and 2, respectively.

### DETAILED DESCRIPTION OF THE PREFERRED EMBODIMENTS

This disclosure of the invention is submitted in furtherance of the constitutional purposes of the U.S. Patent Laws “to promote the progress of science and useful arts” (Article 1, Section 8).

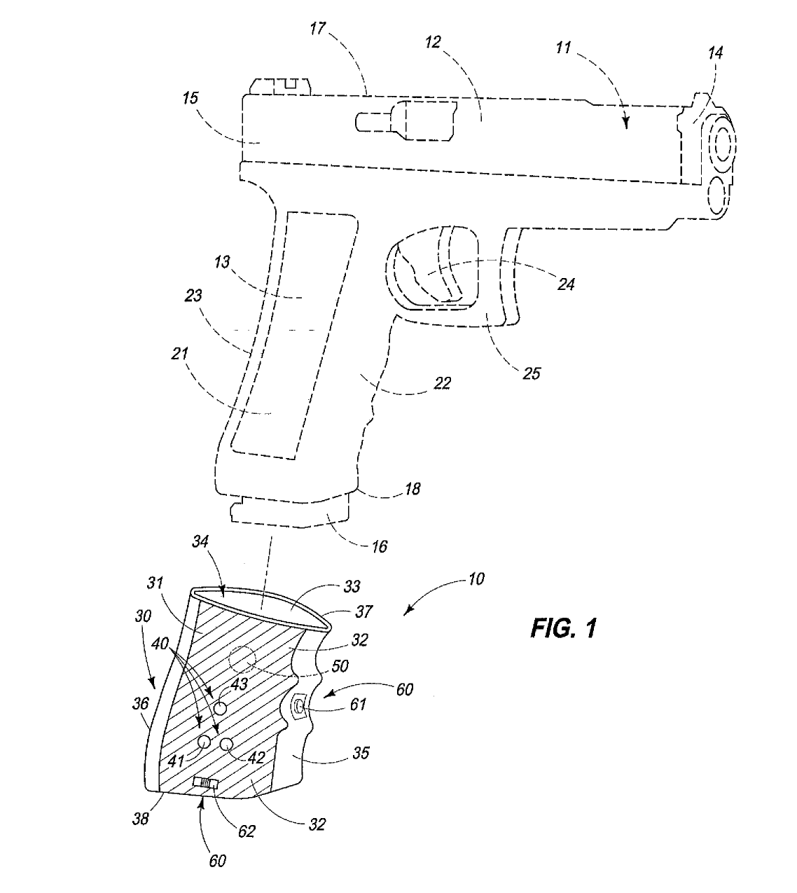

An object location assembly of the present invention is generally indicated by the numeral 10 in FIG. 1 and following. As seen in the drawings, the present invention is operable to be used in combination with an object of interest, and which is generally indicated by the numeral 11. In the present drawings, the object of interest is depicted as a firearm 11 which is of the hand held variety. The firearm includes a main body 12 which has a hand grip 13, and which further is held in, and discharged from the hand of a user (not shown). The hand grip is employed by the user for controlling the orientation and aim of the firearm. Still further, the firearm 11, has a first muzzle end 14; and an opposite, second, breach end 15. Still further, the hand-held firearm is operable to receive a magazine 16 of conventional design, and which encloses several rounds which are individually fired by the firearm 11. The magazine 16 is operable to be matingly and slideably received within a passageway formed in the hand grip 13 as is well known in the art. The firearm as shown in the drawings further has a top portion 17, and an opposite, bottom portion 18. While the object of interest as depicted is a firearm, other objects of interest could benefit from the foregoing invention including tools; hand-held radios; flashlights; medical devices and similar objects.

In addition to the foregoing, the firearm 11, and more specifically the hand grip 13 thereof, has a left side 20, and an opposite right side 21 respectively. Still further, the hand grip 13 includes a forward or muzzle facing peripheral edge 22, and an opposite, rearward or breach facing peripheral edge 23. Still further, the firearm 11 includes a trigger 24 which is positioned adjacent to the forward or muzzle facing peripheral edge 22. The trigger 24 is of traditional design. Still further, the firearm 11 has a trigger housing or guard 25 which encloses the trigger 24 and into which a finger of a user, (not shown) is inserted so as to apply pressure to the trigger 24 thereby causing a discharge of the firearm 11. As will be appreciated, the hand of the user typically grasps and surrounds, at least in part, the hand grip 13 in a manner which is well known in the art.

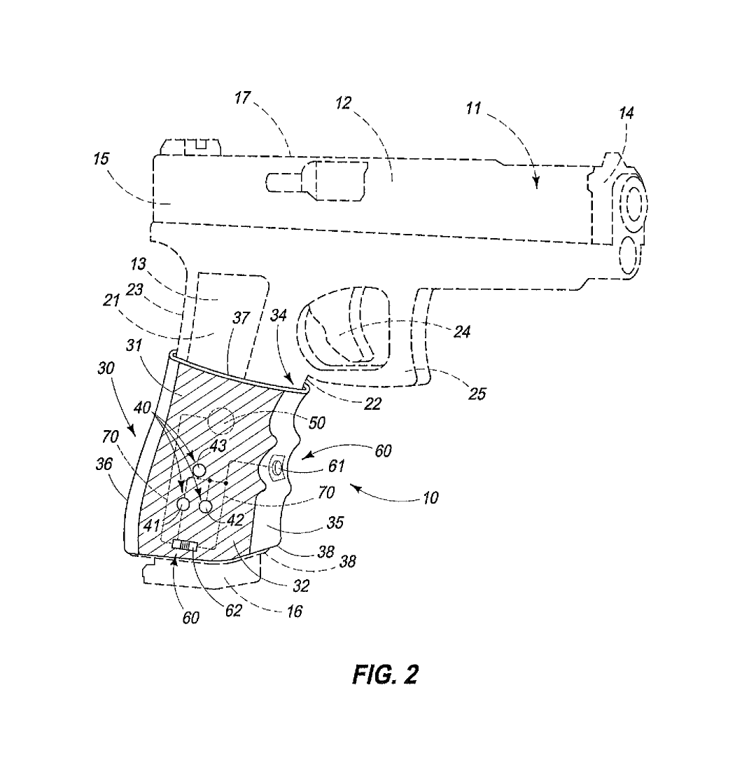

A first form of the invention is generally indicated in FIGS. 1 and 2, respectively. In this regard, the object location assembly 10 includes a flexible and resilient housing which is generally indicated by the numeral 30. The housing is formed into a tubular shaped main body and which is generally indicated by the numeral 31. The main body 31 is fabricated from a stretchable, and resilient material having a given thickness and which can be resiliently and conformably shaped so as to conform to, and be received in close fitting relation thereabout the hand grip 13 of the firearm 11. In this regard, the main body 31 has an outside facing surface 32, and which is typically fabricated in a fashion to provide a high friction-like surface. This ensures a secure grip by the user when handling the firearm 11. Still further, the main body 31 has an inside facing surface 33 which defines an internal cavity 34. The main body can be resiliently deformed so as to provide an appropriately shaped internal cavity which can readily and telescopingly receive the hand grip 13 therewithin. Still further, the main body 30 has a forward facing peripheral edge 35, and a rearward peripheral edge 36. Moreover, the main body has a top peripheral edge 37, and an opposite bottom peripheral edge 38. As will be seen, the main body 31 has a length dimension which is typically less than the length dimension of the hand grip 13 which is made integral with the firearm 11. As seen in the drawings, the main body has a length dimension which permits it to be positioned on the hand grip 13, and below the trigger housing or guard, 25. In one possible embodiment, the main body 31 may be fabricated of a resilient material which provides sufficient friction so as to be reliably and securely located on, and about, the hand grip 13. In another possible form of the invention, a layer of adhesive (not shown) may be applied to the inside facing surface 33 so as to reliably secure the main body 31 in a fixed location on the hand grip 13. The main body has a given thickness dimension which permits other structures to be incorporated or made integral therewithin, and which are further described, below.

The object location assembly 10 of the present invention further includes a plurality of electromagnetic radiation emitters 40 as seen in FIG. 1, and following. The plurality of electromagnetic radiation emitters 40 include individual light emitting diodes (LED's) which are mounted on, and made integral with, the main body 31, and which can be seen from the outside facing surface 32. The plurality of selectively energizable electromagnetic radiation emitters 40, when energized, assist a user (not shown) in visually locating the object of interest, here depicted as a firearm 11, when the object of interest is displaced from the user's body and located in an environment which has reduced ambient lighting conditions. As will be appreciated, the plurality of electromagnetic radiation emitters 40 include, a first emitter 41; a second emitter 42; and a third emitter 43. As should be understood, and as seen in FIG. 2, the first electromagnetic radiation emitter 41, and which is located most closely adjacent to the rearward or breach facing peripheral edge 23 of the hand grip 13, when energized, emits a band of visible electromagnetic radiation, which may be the color red, for example, and which further allows a user (not shown) to quickly visually identify, in a reduced ambient lighting environment, the rearward or breach facing peripheral edge 23 of the hand grip 13. As will be appreciated, any color may be selected which will allow a user to visually identify the breach peripheral edge 33 of the hand grip 13. Still further, the plurality of electromagnetic radiation emitters include a second electromagnetic radiation emitter 42, and which is positioned most closely adjacent to the forward or muzzle facing peripheral edge 22. In this particular case, the respective second electromagnetic radiation emitters 42 which are positioned on the opposite left and right sides 20 and 21, respectively, of the hand grip 13, when energized, emit different bands of visible electromagnetic radiation. These different bands of electromagnetic radiation allow a user to determine, in a reduced ambient lighting environment, which direction the muzzle end 14 of the firearm 11 is facing. For example, if the left side 20 of the hand grip 13 has a second emitter that emits a blue light, when energized, a user may quickly determine that the left side of the firearm is facing upwardly, and then can determine from the orientation of the blue light relative to the light emitted from the first electromagnetic radiation emitter which would be red, (in this example), which direction the muzzle 14 of the firearm 11 is pointing. Of course, the right side 21 of the hand grip 13, and more specifically the second electromagnetic radiation emitter 42 positioned thereon, would emit a different colored light. In the present example, a green light might be selected so that the right side of the firearm could be easily detected in a low ambient lighting environment.

The third electromagnetic radiation emitter 43, as provided, would emit a band of electromagnetic radiation which would allow a user, not shown, to identify the top portion 17, of the object of interest 11. In the example as seen in the drawings, the emitted electromagnetic radiation could, for example, be white in color, although other colors could be selected for each of the respective electromagnetic radiation emitters 40, and which are based upon user preferences or assorted color vision impairments which might be experienced by the user. The respective electromagnetic radiation emitters 40 are energized by a battery of traditional design, and which is generally indicated by the numeral 50. This battery would typically include such button-type batteries that are effective in powering light emitting diodes. The battery 50 is shown only generally in FIG. 1, and following, and is held or otherwise secured in a user accessible pocket, (not shown), and which is made integral with the housing 30. As discussed, above, the electromagnetic radiation emitters 40, when energized, individually emit different colored bands of light which can be visually discerned by the user in the environment having the low ambient light, and which further assists the user in perceiving the orientation of the hand held firearm 11 relative to a viewing position of the user when the hand held firearm is displaced from the body of the user. Again, the first electromagnetic radiation emitter 41 produces the same band of light, and which visually identifies to a user the breach end 15 of the firearm 11; and the second electromagnetic radiation emitter 42, visually identifies the muzzle end 14 of the hand held firearm 11. As noted above, each of the second electromagnetic radiation emitters 42, when energized, emits a different band of light, and which assists the user in visually determining, under low ambient lighting conditions, if the left or right side 20 or 21 of the hand grip 13 is facing the user. Further, the third electromagnetic radiation emitter, when energized, allows a user to identify the top portion 17 of the firearm as depicted in the drawings, under low ambient lighting conditions.

The object location assembly 10 of the present invention includes a pair of electrical switches which are generally indicated by the numeral 60. In this regard, the pair of electrical switches include a first electrical switch 61, which is borne by the housing 30, and which further energizes the plurality of selectively energizable electromagnetic radiation emitters 40 when the object of interest, such as the firearm 11, is displaced from a user's body. In the arrangement as shown, when the first electrical switch 61 is forcibly engaged by the hand or a finger of the user, the respective electromagnetic radiation emitters 40 remain deenergized. Still further, the pair of electrical switches includes a second electrical switch 62 which electrically activates and deactivates the object location assembly 10. In this regard, the first mentioned electrical switch 61 electrically cooperates with the second electrical switch 62 to selectively energize and de-energize the plurality of electromagnetic radiation emitters 40.

As seen in FIG. 2, the object location assembly 10 includes a multiplicity of electrical conductors 70 which are embedded or otherwise enclosed within the main body 31 of the housing 30, and which further electrically couple the battery 50, which delivers a source of electrical power, to the plurality of electromagnetic radiation emitters 40, and the pair of electrical switches 60, respectively. The operation of the object location assembly 10 will be discussed in greater detail, below.

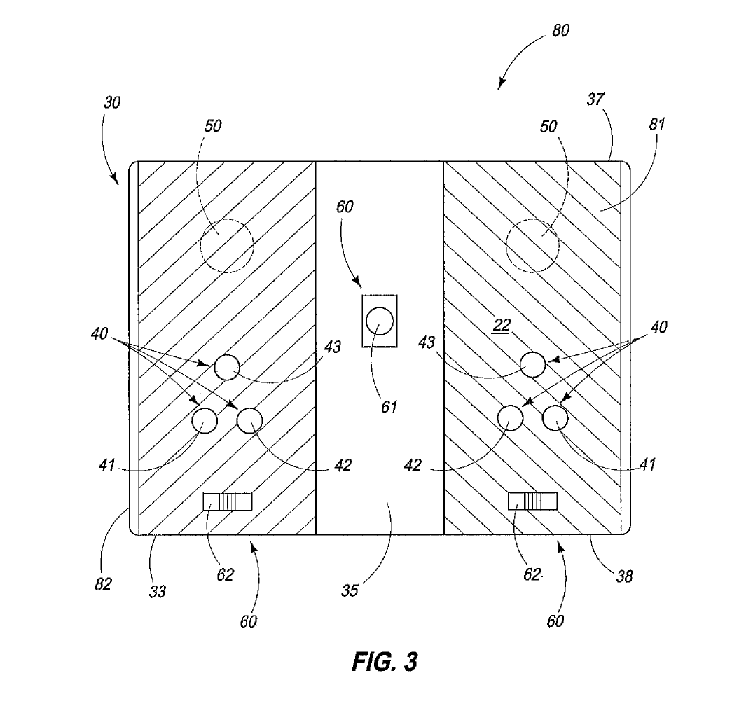

Referring now to FIG. 3, a second form of the invention 10 is illustrated, and which is generally indicated by the numeral 80. The second form of the invention 80 is shown, in a side elevation view, and wherein similar structures bear similar numbers from the previous form of the invention which was earlier described. However, it will be noted from studying FIG. 3 that the second form of the invention 80, has a main body 81 which is formed of a resilient and flexible material, and which can be wrapped or otherwise attached to the grip 13 of the object of interest, and which is depicted as the firearm 11 as seen in FIGS. 1 and 2. As was described in the first form of the invention, and as seen in FIG. 1, the housing 30 includes a main body 31 which defined an internal cavity 34. In the second form of the invention 80, the main body 81 is operable to be folded or wrapped, at least in part, about the hand grip 13 of the firearm 11 thereby providing a convenient means for attaching the main body 81 to firearm hand grips of different shapes and sizes. Again, the main body 81, has an inside facing surface indicated by the numeral 33, and wherein the inside facing surface has attached thereto a layer of adhesive 82 which is operable to secure the main body 81 in a fixed orientation relative to the hand grip 13. Again, referring to FIG. 3, it will be understood that the first electrical switch 61 will be located adjacent to the forward or muzzle facing peripheral edge 22 of the hand grip 13 and can be forcibly engaged by the handle or the finger of a user in the manner which is described in greater detail below.

### OPERATION

The operation of the described embodiments of the present invention are believed to be readily apparent, and are briefly summarized at this point.

In its broadest aspect, the present invention relates to an object location assembly 10, and which includes a housing 30, and which further is releasably mounted on an object of interest 11, and carried on a user's body or in a user's hand (not shown). The object of interest 11 has opposite ends 14, and 15, opposite sides, 20 and 21, and top and bottom portions 17 and 18 respectively. The invention also includes a plurality of selectively energizable electromagnetic radiation emitters 40 which are mounted on, or made integral with, the housing 30, and which further are oriented in a predetermined spatial pattern on the housing 30, and which, when energized, assist the user in visually locating the object of interest 11 when the object of interest is displaced from the user's body, or dropped, and then located in an environment which has reduced ambient lighting conditions. Still further, the object location assembly 10 includes an electrical switch 61 which is borne by the housing 30, and which energizes the plurality of selectively energizable electromagnetic radiation emitters 40 when the object of interest 11 is displaced from the user's body. As noted earlier, when the electrical switch 61 is forcibly engaged by the hand or a finger of a user, the respective electromagnetic radiation emitters 40 remain deenergized. However, when released, the electromagnetic radiation emitters become energized and produce light which can be seen by the user.

As illustrated, the object of interest comprises a hand-held firearm 11 which has a hand grip 13 for controlling the firearm. The housing 30 conformably, and releasably mates with the hand grip 13 of the firearm 11. While a firearm is depicted, other objects of interest such as flashlights, radios, various tools and other objects which might be carried in the hand or on the body of a user may utilize the present invention. Further, and while the housing 30 is depicted, herein, and which is discussed in terms of being a resilient flexible substrate, membrane or similar structure, and which conformably mates to the hand grip 13 of the firearm 11, this housing may further be fabricated from a rigid substrate or further the object detection assembly may be made integral with the hand grip 13 of the firearm 11 during fabrication.

The object location assembly 10 of the present invention further includes a battery 50 which is borne by the housing 30, and which selectively energizes the plurality of electromagnetic radiation emitters 40 as earlier discussed. The invention 10 also includes a second electrical switch 62 which electrically activates and deactivates the object location assembly 10. The first mentioned electrical switch 61 electrically cooperates with the second electrical switch 62 to selectively energize and deenergize the plurality of electromagnetic radiation emitters 40. In the arrangement as discussed in this application, the object of interest 11 has opposite sides 20 and 21, respectively. The plurality of electromagnetic radiation emitters 40 are mounted in a given spatial pattern on the opposite sides 20 and 21 of the object of interest 11, so as assist the user in visually discerning an orientation of the object of interest 11 once the user visually perceives the object of interest under the environmental conditions which have the low ambient light. In the arrangement as shown in the drawings, the given spatial pattern of the respective electromagnetic radiation emitters 40 facilitates a user in visually perceiving the orientation of the object of interest 11; which side of the object of interest is facing the user under the low ambient lighting conditions; and where the top portion 17 of object of interest is located relative to the user's vantage point.

More specifically, the present invention relates to an object location assembly 10 which includes a flexible housing 30 which is releasably mounted on an object of interest 11 and which is carried by a hand of a user (not shown). The object of interest 11, from time-to-time, can be released by the hand of the user and be displaced a given distance from the user. In the arrangement as seen, a plurality of selectively energizable light emitters 40 are mounted on the flexible housing 30, and which are further oriented in a predetermined spatial pattern. The selectively energizable light emitters 40, when energized, assist the user in visually perceiving the object of interest 11, and the relative orientation of the object of interest 11, and which is displaced from the user, under an environmental condition which has reduced ambient light. In the arrangement as seen in the drawings, a pair of electrical switches 60 which are borne by the flexible housing 30, operate, in combination, to selectively energize the respective light emitters 40 which are mounted on the flexible housing 30 when the object of interest 11 is displaced from the hand of the user.

In the arrangement as seen in the drawings, the battery 50 is mounted on the flexible housing 30, and which further provides a source of electrical power for energizing the respective light emitters 40. The pair of electrical switches 60 comprise a first electrical switch 61, which, when forcibly engaged by the hand of the user, prevents the selectively energizable light emitters 40 from becoming energized. Still further, the invention includes a second electrical switch 62 which electrically activates and deactivates the object location assembly 10. The object location assembly 10 when electrically activated by the second electrical switch 62, allows the selectively energizable light emitters 40 mounted on the flexible housing 30 to become energized, and emit visible light, when the hand of the user is removed from the first electrical switch 61.

As illustrated in the drawings, the object of interest 11 comprises a hand-held firearm 11 having a hand grip 13 for controlling the movement of the firearm 11. The firearm has a first, muzzle end 14, and a second, breach end 15. The hand grip 13 is mounted adjacent to the breach end 15 of the hand-held firearm 11, and further has a forward, muzzle facing, and an opposite, breach facing peripheral edge 22 and 23, respectively. The hand grip 13 further has opposite left and right sides 20 and 21, respectively. The spatial pattern of the plurality of selectively energizable light emitters 40 comprises three light emitters which are positioned on each of the left and right sides 20 and 21, respectively of the hand grip 13 by the flexible housing 30. The respective light emitters 41, 42, and 43, when energized, individually emit differently bands of light which can be visually discerned by the user in the environment having the low ambient light, and which assists the user in perceiving the orientation of the hand-held firearm 11 relative to a viewing position of the user when the hand-held firearm 11 is displaced from the hand of the user.

In the arrangement as seen in the drawings, the selectively energizable light emitters 40 most closely adjacent to the breach facing peripheral edge 23 of the hand grip 13 each emit, when energized, the same band of light so as to assist the user in visually discerning the second, breach end 15 of the firearm 11. As should be understood, the selectively energizable light emitters 41 which are individually located most closely adjacent to the first, muzzle facing, peripheral edge 22 of the hand grip 13, when energized, each emit bands of light which are different from each other, and which are further different from the band of light which is emitted by the selectively energizable light emitters 42 which are located most closely adjacent to the breach facing peripheral edge 23 of the hand grip 13. The energized light emitters 40 most closely adjacent to the first, muzzle facing peripheral edge 22 of the hand grip 13, allows a user to visually discern the orientation of the muzzle end 14 of the hand held firearm 11 relative to the user, and further allows a user to discern which side 20 or 21, respectively, of the firearm 11 is facing in the direction of the user. The third light emitter 43 allows a user to discern the top portion 17 of the object of interest, 17. As seen in the drawings, the first electrical switch 61 is located adjacent to the first muzzle facing peripheral edge 22 of the hand grip 13, and is forcibly engaged by the hand or the finger of the user. As should be understood, when the first electrical switch is forcibly depressed by the hand or the finger of the user, and assuming the second electrical switch 62 is activated, no electrical power from the battery 50 is supplied to the respective electromagnetic radiation emitters 40. However, if the object of interest 11 is dropped or otherwise displaced such that no force is applied to the first electrical switch 61, the assembly 10 is operable to energize the respective electromagnetic radiation emitters 40 so as to emit light which allows the user to discern the orientation and position of the object of interest 11 relative to the observer under adverse or low ambient lighting conditions thereby facilitating the recovery of the object of interest 11 in a safe manner. The first electrical switch 61 is further operable, following a second application of force to the same switch to become deactivated and consequently deenergize the plurality of electromagnetic radiation emitters, 40. This would allow, for example a user to holster the firearm, as illustrated, without the electromagnetic radiation emitters being energized. As should be appreciated, the first electrical switch 61 is inoperable when the second electrical switch 62 is deactivated, as discussed, above, and which results in a deenergizing of the respective electromagnetic radiation emitters 40. In the arrangement as illustrated the second electrical switch 62 is placed in either the activated (energized), or deactivated (deenergized) state when physical force is applied by the user to the second electrical switch 62. While the present invention, above discloses electromagnetic radiation emitters which generate radiation which can be typically, visually perceived by the user, it is, of course, possible to fabricate a device which utilizes emitters which when energized, emit electromagnetic radiation which is invisible to the user, and which may be useful for the same, or other purposes.

Therefore, it will be seen that the present invention provides a convenient assembly which can be readily attached to an object of interest such as a firearm, radio, tool or the like, and which is carried in the hand of a user, and which further, when accidently displaced from the user's body can be quickly located under low ambient lighting conditions. Further, the user may visually perceive and determine the orientation of the object of interest so as to recover and pick up the object of interest in a safe manner.

In compliance with the statute, the invention has been described in language more or less specific as to structural and methodical features. It is to be understood, however, that the invention is not limited to the specific features shown and described, since the means herein disclosed comprise preferred forms of putting the invention into effect. The invention is, therefore, claimed in any of its forms or modifications within the proper scope of the appended claims appropriately interpreted in accordance with the doctrine of equivalents.

I claim:

1. An object location assembly, comprising:
a housing which is mounted on an object of interest, and which is carried by a user, and wherein the object of interest has opposite ends, opposite sides, and top and bottom portions; and
a multiplicity of selectively energizable electromagnetic radiation emitters which are mounted in a predetermined spatial pattern on the housing, and which, when selectively energized, emits electromagnetic radiation which allows the user, under a reduced ambient lighting condition, to readily discern the relative orientation of the object of interest when the object of interest is located at a predetermined distance away from the user.

2. An object location assembly as claimed in claim 1, and wherein the electromagnetic radiation includes visible and/or invisible bands of electromagnetic radiation.

3. An object location assembly as claimed in claim 2, and wherein the object location assembly includes a battery which is mounted on the housing, and which selectively energizes the multiplicity of selectively energizable electromagnetic radiation emitters.

4. An object location assembly as claimed in claim 3, and further comprising a pair of electrical switches which are electrically coupled to the battery, and which further operate, in combination, to selectively energize, and deenergize the multiplicity of electromagnetic radiation emitters when the object of interest is utilized by the user, or located at the predetermined distance from the user.

5. An object location assembly as claimed in claim 4, and wherein the pair of electrical switches includes a first electrical switch which, if continually forcibly engaged by the user, prevents the plurality of electromagnetic radiation emitters from becoming energized, so as to inhibit the emission of electromagnetic radiation, and wherein the first electrical switch is effective, when force is removed from the first electrical switch to electrically energize the respective electromagnetic radiation emitters, and facilitate the emission of electromagnetic radiation, and wherein the first electrical switch is effective following a second application of force to the first electrical switch to deenergize the respective plurality of electromagnetic radiation emitters, and wherein the pair of electrical switches includes a second electrical switch which selectively activates and deactivates the object location assembly, and wherein the first electrical switch is inoperable when the second electrical switch is deactivated.

6. An object location assembly as claimed in claim 5, and wherein the second electrical switch is physically placed by the user in the energized and deenergized state.

7. An object location assembly as claimed in claim 5, and wherein the second electrical switch is placed in the energized and deenergized state from a remote location.

8. An object location assembly as claimed in claim 5, and wherein the plurality of electromagnetic radiation emitters mounted on the housing are disposed in a spatial pattern on the opposite sides of the object of interest, and wherein the plurality of electromagnetic radiation emitters located on each side of the object of interest includes a first electromagnetic radiation emitter which when energized produce the same band of light, and which visually identifies to the user, one end of the object of interest; a second electromagnetic radiation emitter which is spaced from the first emitter, and which, when energized, visually identifies the opposite end of the object of interest; and wherein each of the second electromagnetic radiation emitters, when energized, emits a different band of electromagnetic radiation, and which further assists the user in visually determining, under the low ambient lighting conditions, if the left or right side of the object of interest is facing the user; and a third electromagnetic radiation emitter, which is spaced from the first and second electromagnetic radiation emitters, and which visually identifies the top portion of the object of interest.

9. An object location assembly as claimed in claim 8, and wherein the housing is operable to enclose at least a portion of the object of interest.

10. An object location assembly, comprising:
a housing which is mounted on an object of interest, and which is carried on a user's body;
a plurality of selectively energizable electromagnetic radiation emitters which are mounted on the housing, and which, when energized, assist the user in visually locating the object of interest when the object of interest is displaced from the user's body and located in an environment which has reduced ambient lighting conditions; and
an electrical switch which is borne by the housing, and which energizes the plurality of selectively energizable electromagnetic radiation emitters when the object of interest is displaced from the user's body.

11. An object location assembly as claimed in claim 10, and wherein the electrical switch has first, second and third operational positions, and wherein in the first operational position, and when force is first, continually applied to the electrical switch, the electrical switch is operable to maintain the electromagnetic radiation emitters in a deenergized state, and wherein the electrical switch, when the continual force is removed therefrom, assumes the second operational position, and which is effective to energize the respective electromagnetic radiation emitters, and wherein when force is applied on a second occasion to the electrical switch, the electrical switch assumes the third operational position, and where the respective electromagnetic radiation emitters remain deenergized without continued force being applied to the electrical switch.

12. An object location assembly as claimed in claim 11, and wherein the object of interest comprises a hand-held firearm which has a hand grip for controlling the firearm, and wherein the housing conformably mates to the hand grip of the firearm.

13. An object location assembly as claimed in claim 12, and further comprising a battery which is borne by the housing, and which selectively energizes the plurality of electromagnetic radiation emitters.

14. An object location assembly as claimed in claim 13, and further comprising a second, electrical switch which electrically activates and deactivates the object location assembly, and wherein the first mentioned electrical switch electrically cooperates with the second electrical switch to selectively energize and deenergize the plurality of electromagnetic radiation emitters, and wherein the first mentioned electrical switch is inoperable when the second electrical switch is deactivated.

15. An object location assembly as claimed in claim 14, and wherein the object of interest has opposite sides, opposite ends, and top and bottom portions, and wherein the plurality of electromagnetic radiation emitters are mounted in a given spatial pattern on the opposite sides of the object of interest, so as assist the user in visually discerning an orientation of the object of interest once the user visually perceives the object of interest under the environmental conditions which have the low ambient light.

16. An object location assembly as claimed in claim 15, and wherein the given spatial pattern of the respective electromagnetic radiation emitters facilitates a user in visually perceiving both the orientation of the object of interest, and which side, and portion of the object of interest, is facing the user.

17. An object location assembly as claimed in claim 16, and wherein the object of interest comprises a hand-held firearm having a hand grip for controlling the firearm, and wherein the firearm has a first, muzzle end, a second, breach end, a top portion, and a bottom portion, and wherein the hand grip is mounted adjacent to the breach end of the hand-held firearm, and further has a forward, muzzle facing, and an opposite, breach facing peripheral edge, and wherein the hand grip further has opposite left and right sides, and wherein the spatial pattern of electromagnetic radiation emitters comprises three electromagnetic emitters which, when energized, individually emit differently colored bands of light, and which can be visually discerned by the user in the environment having the low ambient light, and which further assists the user in perceiving the orientation of the hand-held firearm relative to a viewing position of the user when the hand-held firearm is displaced from the body of user.

18. An object location assembly as claimed in claim 17, and wherein the respective electromagnetic emitters mounted on each side of the firearm includes a first electromagnetic radiation emitter producing the same band of light, and which visually identifies to the user the breach end of the hand-held firearm; a second electromagnetic radiation emitter which is spaced from the first emitter, and which visually identifies the muzzle end of the hand-held firearm, and wherein each of the second electromagnetic radiation emitters, when energized, emits a different band of light, and which assists the user in visually determining, under the low ambient lighting conditions, if the left or right side of the hand-grip is facing the user; and a third electromagnetic radiation emitter which is spaced from the first and second electromagnetic emitters, and which further visually identifies the top portion of the hand-held firearm.

19. An object location assembly as claimed in claim 18, and wherein each of the first electromagnetic radiation emitters emit visible red light; and the second, electromagnetic radiation emitter which is located on the left side of the hand grip emits blue light so as to assist a user in visually identifying the left side of the hand grip, and wherein the second electromagnetic radiation emitter which is located on the right side of the hand grip emits yellow light so as to assist a user in visually identifying the right side of the hand grip, and wherein the third electromagnetic radiation emitter emits white light.

20. An object location assembly as claimed in claim 10, and wherein the object of interest comprises a hand-held firearm which has a hand grip for controlling the firearm, and wherein the housing defines a cavity for enclosing, at least in part, a portion of the hand grip.

21. An object location assembly as claimed in claim 20, and wherein the housing is fabricated, at least in part, of a resilient substrate which conformably mates to the hand grip, and wherein the housing has an outside facing, high friction surface texture.

22. An object location assembly as claimed in claim 10, and wherein the object of interest comprises a hand-held firearm which has a hand grip for controlling the firearm, and wherein the housing comprises a flexible membrane having both inwardly and outwardly facing surfaces, and wherein the flexible membrane can be wrapped, at least in part, around the hand grip of the firearm.

23. An object location assembly as claimed in claim 22, and wherein the inside facing surface of the flexible membrane is secured to the hand grip of the firearm by a releasable adhesive which is deposited on the inside facing surface of the flexible membrane, and wherein the outwardly facing surface of the flexible membrane has a high friction surface texture.

24. An object location assembly, comprising:
a flexible housing which is releasably mounted on an object of interest, and which is carried by a hand of a user, and wherein the object of interest, from time-to-time, can be released by the hand of the user, and be displaced a given distance from the user;
a plurality of selectively energizable light emitters mounted on the flexible housing, and which are further oriented in a predetermined spatial pattern, and wherein the selectively energizable light emitters, when energized, assist the user in visually perceiving the object of interest, and the relative orientation of the object of interest when the object of interest is displaced from the user, under an environmental condition which has reduced ambient light; and
a pair of electrical switches which are borne by the flexible housing, and which operably, in combination, selectively energize and deenergize the respective light emitters which are mounted on the flexible housing when the object of interest is displaced from the hand of the user.

25. An object location assembly as claimed in claim 24, and further comprising a battery which is mounted on the flexible housing, and which further provides a source of electrical power for energizing the respective light emitters, and wherein the pair of electrical switches comprise a first electrical switch, which, when first forcibly engaged by the hand of the user, prevents the selectively energizable light emitters from becoming energized so long as continual force is applied by a hand of the user to the first electrical switch, and wherein when force is removed from the first electrical switch, the first electrical switch is effective in energizing the respective light emitters, and wherein when force is applied a second time to the first electrical switch, the first electrical switch is effective in deenergizing the respective light emitters, and wherein the pair of electrical switches include a second electrical switch which electrically activates, and deactivates the object location assembly, and wherein the object location assembly, when electrically activated by the second electrical switch, allows the selectively energizable light emitters mounted on the flexible housing to become energized, and emit light, when the hand of the user is removed from the first electrical switch.

26. An object location assembly as claimed in claim 16, and wherein the object of interest comprises a hand-held firearm having a hand grip for controlling the firearm, and wherein the firearm has a first, muzzle end, and a second, breach end, and wherein the hand grip is mounted adjacent to the breach end of the hand-held firearm, and further has a forward, muzzle facing, and an opposite, breach facing peripheral edge, and wherein the hand grip further has opposite left and right sides, and wherein the spatial pattern of the plurality of selectively energizable light emitters comprises a multiplicity of light emitters positioned on each of the left and right sides of the hand grip by the flexible housing, and which, when energized, individually emit differently colored bands of light which can be visually discerned by the user in the environment having the low ambient light, and which assists the user in perceiving the orientation of the hand-held firearm relative to a viewing position of the user when the hand-held firearm is displaced from the hand of the user.

27. An object location assembly as claimed in claim 26, and wherein the selectively energizable light emitters most closely adjacent to the breach facing peripheral edge of the hand grip each emit, when energized, the same band of visible light so as to assist the user in visually discerning the second, breach end of the firearm, and wherein the selectively energizable light emitters which are individually located most closely adjacent to the first, muzzle facing, peripheral edge of the hand grip, when energized, each emit visible bands of light which are different from each other, and which are further different from the band of light which is emitted by the selectively energizable light emitters located most closely adjacent to the breach facing peripheral edge of the hand grip, and wherein the energized light emitters most closely adjacent to the first, muzzle facing peripheral edge of the hand grip, allows a user to visually discern the orientation of the muzzle end of the hand held firearm relative to the user, and further allows a user to visually discern which side of the firearm is facing in the direction of the user, and wherein each side of the firearm includes a third light emitter which visually identifies a top portion of the hand-held firearm.

28. An object location assembly as claimed in claim 27, and wherein the first electrical switch is located adjacent to the first muzzle facing peripheral edge of the hand grip, and is forcibly engaged by the hand of the user.
